(19) United States
(12) Patent Application Publication
(10) Pub. No.: US 2016/0207835 A1
(43) Pub. Date: Jul. 21, 2016

(54) PLASTIC STONE COMPOSITE

(71) Applicant: Wei-Teh Ho, Taipei (TW)

(72) Inventor: Jian Guo Zheng, Zhejiang Lishui (CN)

(21) Appl. No.: 14/615,242

(22) Filed: Feb. 5, 2015

Related U.S. Application Data
(60) Provisional application No. 62/105,658, filed on Jan. 20, 2015.

(51) Int. Cl. C04B 32/00

(52) U.S. Cl. CPC C04B 32/005

(57) ABSTRACT

A plastic stone composite comprising PVC and calcium carbonate to provide desired physical characteristics of both plastics and natural stones is disclosed. The plastic stone composite can be made of PVC having low molecular weight grade with K value less than 60, calcium carbonate powder characterized by particle sizes smaller than 400 mesh, and more than one additive. For example, the additives can include calcium zinc stabilizer, chlorinated polyethylene, polyethylene wax, stearic acid plasticizer, and acrylic processing aid.

### CROSS-REFERENCE TO RELATED APPLICATIONS

This application claims the benefit of U.S. Provisional Application No. 62/105,658, entitled “Plastic Stone Composite”, Jian Guo Zheng, filed Jan. 20, 2015, which is hereby incorporated by reference herein in its entirety.

### FIELD OF INVENTION

The present invention relates generally to composite material, and in particular, to plastics based composite material for manufactured stonelike material.

### BACKGROUND

There is an increasing need for replacement material of natural stone. With the fast urban development of human society, availability of natural stone material has become less attainable. The cost of accessing the remaining limited resources of natural stone only increases as development progresses. Additionally, there is a high processing cost required for quarrying natural stone, such as environmental impacts, amount of water needed, pollution incurred, etc.

Industrial material, such as Polyvinyl chloride (PVC), e.g. with structure —(CH2-CHCl)n-, has certain desired physical properties similar to natural stones. For example, PVC material typically comes with tensile strength around 60 MPA (megapascal), impact strength around 5˜10 kj/m2 (Charpy impact strength value) and excellent dielectric properties. In practice, various stabilizers and/or additives are added to PVC to maintain certain properties of PVC based material.

Specifically, PVC is composed of vinyl chloride polymerization under the action of an initiator of the thermoplastic resin. It is a homopolymer of vinyl chloride. Vinyl chloride homopolymer system and vinyl chloride are called vinyl chloride copolymer resin. Raw PVC material may be formed as white powder with amorphous structure. Industrially produced PVC tends to have large polydispersity with molecular weights ranging from 50000 to 120000. Molecular weight of PVC increases as its polymerization temperature decreases. There is no fixed melting point for PVC material. For example, it can begin to soften at about 80˜85° C., enter into a viscoelastic state at around 130° C., and become a viscous flow at around 160˜180° C. PVC material can be hard with poor solubility only dissolving into a few solvents such as cyclohexanone, dichloroethane and tetrahydrofuran. PVC possesses stable chemical properties with organic and inorganic acid, alkali, salt.

However PVC's chemical stability decreases when the temperature increases and PVC has unstable physical properties related to heat and light. When exposed to more than 100° C. heat or directly under the sunlight for a long time, it will decompose, produce hydrogen chloride with automatic catalytic decomposition and cause discoloration and rapid deteriorations of physical and mechanical functions/properties.

Thus, the conventional PVC based material does not possess the desired properties of natural stone.

### SUMMARY OF THE DESCRIPTION

A plastic stone composite material can be formed by mixing selected types of PVC resin with coarse and whiting calcium powder aided with additives such as plasticizer, lubricants and processing aids. The plastic stone composite can be used to manufacture artificial stonelike material or products with desired physical properties of both natural stones and manmade plastics.

A plastic stone composite can comprise about 30-50 parts by weight of PVC having low molecular weight grade with K value less than 55-60, about 50-70 parts by weight of calcium carbonate powder characterized by particle sizes smaller than 400 mesh, about 7.5-10.4 parts by weight of more than one additive. In one embodiment, the additives can include about 2-3 parts by weight of calcium zinc stabilizer, about 2-2.5 parts by weight of chlorinated polyethylene, about 0.3-0.5 parts by weight of polyethylene wax, about 0.5-0.8 parts by weight of stearic acid, about 1.5-2 parts by weight of plasticizer; and about 1.2-1.6 parts by weight of acrylic processing aid.

In another embodiment, a process to prepare plastic stone composite material can include providing PVC of about 30-50 parts by weight, the PVC having low molecular weight grade with K value less than 60. Calcium carbonate powder can be surface treated with at least two treating agents for uniform dispersion among calcium carbonate particles of the powder. The calcium carbonate particles may be sized between 400 and 800 mesh. The treating agents can include an organic agent based on aluminum acetate and an inorganic agent having silane. The surface treated powder of about 50-70 parts by weight may be mixed with more than one additive about 7.5-10.4 parts by weight, together with the PVC, into a mixture in a plastic extruder. Heat can be applied to melt the mixture at a desired temperature (e.g. 190-210° C. or Celsius degree) under a suitable pressure to form the plastic stone composite material.

Other advantages and features of the present invention will become manifest to those versed in the art upon making reference to the detailed description in which a preferred structural embodiment incorporating the principles of the present invention is shown by way of illustrative example.

### DETAILED DESCRIPTION

In the following detailed description, specific preferred embodiments of the invention are described to enable a full and complete understanding of the invention. It will be recognized that it is not intended to limit the invention to the particular preferred embodiment described, and although specific terms are employed in describing the invention, such terms are used in a descriptive sense for the purpose of illustration and not for the purpose of limitation. It will be apparent, however, to one skilled in the art that the present invention may be practiced without these specific details. Further specific numeric references such as first, second, third, etc., may be made. However, the specific numeric references should not be interpreted as a literal sequential order but rather interpreted as references to different objects. Thus, the specific details set forth are merely exemplary. The specific details may be varied from and still be contemplated to be within the scope of the present invention.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

The instant invention is directed to plastic stone composite material which possesses desired physical properties. For example, similar to manmade plastics, the plastic stone composite is light in weigh and moldable for different shapes/forms. Additionally, it is hard to break and even stronger than natural stones. Stamping technologies, such as hot stamping, dry printing of lithography or other surface stamping technologies may be applied on surfaces of the plastic stone material to provide decorative aesthetic effects or to provide an appearance similar to natural stones. Further, the use of plastic stone composite is environmentally friendly and the manufacturing process consumes a limited number of accessible resources. In particular, the plastic stone composite is made of readily available raw material and the composite itself is recyclable.

In one embodiment, the stone plastic composite material can be made of the following components: PVC resin 30-50 weight parts, coarse whiting powder (e.g. calcium carbonate) 50-70 weight parts, calcium zinc or other applicable thermal stabilizer 2-3 weight parts, chlorinated polyethylene or other applicable resistance additives 2-2.5 weight parts, polyethylene wax or other applicable external lubricants 0.3-0.5 weight parts, stearic acid or other applicable internal lubricants 0.5-0.8 weight parts, dioctyl phthalate or other applicable plasticizer 1.5-2 weight parts, acrylic or other applicable processing aid 1.2-1.6 weight parts. These components may be uniformly mixed into a mixture. The mixture may be heated to about 190-210° C. (or other applicable temperature) and melted in a molding machine or an extruder (e.g. a two screw extruder) under a proper pressure (e.g. between 1000-5000 psi or other applicable pressure) to make the plastic stone composite material (when cooled) in desired shapes/forms or extruded in granulation.

A thermal stabilizer may be added to the composite for increasing stability to heat/light. External lubricants (e.g. polyethylene wax) may help creating smooth surfaces (e.g. high gloss surface) or other aesthetic properties of the composite. Resistance additives (e.g. chlorinated polyethylene) may improve heat, oil, weather or other environmental resistance of the composite. Internal lubricants (e.g. stearic acid) may improve thermal stability in engineering plastics processing, for example, to prevent adhesion of the mold and equipment and/or melting of raw materials (bridge phenomenon). Processing aids (e.g. ACR or acrylic processing aid) may speed up PCV melting, promote fusion (e.g. faster fusion), improve melt strength, enhance mixing, eliminate surface defects, and decrease plate-out effects (e.g. undesired coating) during plastics processing for the composite.

Chlorinated polyethylene or CPE (e.g. with structure [CH2-CHCl—CH2-CH2]n) may appear as white powder which is non-toxic, fragrance free, heat tolerable, chemical tolerable, oil tolerable, fire resistance and able to be colored. It can be extracted from HDPE (high-density polyethylene). Based on its structure and purpose, there may be two types of CPE: resin CPE and resilience CM (elastomeric chlorinated polyethylene).

Calcium zinc (Ca—Zn compound) thermal stabilizer may comprise solid stabilizer or liquid stabilizer. The thermal stabilizer may contain calcium salt, zinc salt, lubricant, and antioxidant. It can replace certain stabilizers which contain poison; it may also appear more stable in heating, lighting, and transparency. In PVC products, calcium zincthermal stabilizer shows good results in extra work processes, and can be a non-poisonous stabilizer.

Polyethylene wax may be commonly used due to its cold and heat tolerability, chemical tolerability, and wear resistance tolerability. In normal manufacturing processes, polyethylene wax can be added into polyolefin to finish and strengthen the work as a lubricant. Polyethylene wax is a stable chemical with excellent electrical properties. Polyethylene wax, polyethylene, polypropylene, ethylene propylene rubber, and butyl rubber may be compatible as well. Compared with PVC and other lubricants, polyethylene wax may have better lubricating effects.

Stearic acid as a lubricant may correspond to a component of fats from animal and vegetable fatty acid. Main components of stearic acid lubricant may include stearic acid (C₁₈H₃₆O₂) and palmitic acid (C₁₆H₃₂O₂).

In one embodiment, a major ingredient of the plastic stone composite comprises coarse whiting powder (e.g. calcium carbonate). Particle sizes of the coarse whiting powder could affect the physical properties of the plastic stone composite. In some embodiments, the particle size of the coarse whiting powder selected may be less than 400 mesh (e.g. 37 micrometers). In some embodiments, the particle size of the course whiting powder selected may be greater than about 800 mesh (about 18 micrometers). However, if the particle size of the coarse whiting powder is unsuitable (e.g. too small or too large), desired physical properties (e.g. stonelike strength, smoothness of surface, etc.) may be lacking in the resulting composite.

In one embodiment, a major ingredient of the plastic stone composite comprises PVC resin made via suspension polymerizations to afford particles with average diameters of 100-180 μm (micrometers). Preferably, the PVC resin of a grade higher than SG-9 (suspension grade 9) may be selected for the stone plastic composite. Certain desired properties of the plastic stone composite, such as sleekness in the surface, similarities to natural stones (e.g. in strength/stability), etc. may depend on the proper grade of the PVC resin selected. Using PVC resin of a lower grade (e.g. different from SG-9) as an ingredient may result in a composite material with a non-polished surface appearance significantly different from the desired properties of natural stone.

The grade of PVC resin may be determined by its molecular weight. For example, the molecular weight of PVC of a grade higher than SG-9 may be characterized by (a) viscosity number (ml/g) less than 73, (b) K value (e.g. empirical parameter closely related to intrinsic viscosity) less than 55, and/or (c) mean polymerization degree less than 650.

In some embodiments, the coarse whiting powder may be prepared via a special surface treatment prior to being mixed with PVC resin for the plastic stone composite. Fine particle-sized (or thin), raw (or untreated) coarse whiting powder may easily aggregate in the presence of PVC resin to cause uneven mixtures. The bonding strength between an inorganic material, such as raw coarse whiting powder, and PVC resin may not be strong enough for the desired properties of the plastic stone composite. The surface treatment can facilitate even dispersion of the treated coarse whiting powder within the PVC resin and enhance bonding strength with the PVC resin.

In one embodiment, the surface treatment may include separate applications of different coupling agents on the coarse whiting powder to effectively prevent undesired aggregation (e.g. sticking together) and/or strengthen the adhesion (or bonding) with PVC resin. For example, the raw coarse whiting powder (e.g. 100 kg weight amount) may be mixed (e.g. in a first surface treatment) with an organic coupling agent solution, such as aluminate coupling agent solution, for about 60-90 minutes (or other suitable period of time for the mixed solution to stabilize). The organic coupling agent (e.g. including organic metal salt) may improve dispersion of the coarse whiting powder in the presence of an organic material.

Subsequently, a proper amount of an inorganic coupling agent solution, such as silane coupling agent, is added (e.g. in a second surface treatment) to the mixed organic coupling agent solution and mixed for about 40 to 60 minutes. The mixture can then be dried, such as vacuum dried with ethanol recycled, to obtain the surface-treated coarse whiting powder. The combined effects between the organic and inorganic coupling agents may provide a wrapping effect around calcium carbonate particles in the course whiting powder to alleviate the undesired aggregations among calcium carbonate particles. Additionally, the combined effects can provide surface active groups of the calcium carbonate particles to strengthen the bondage with the PVC resin and improve the effective utilization of the coarse whiting powder.

In one embodiment, the organic coupling agent solution may include a mixture of aluminate coupling agent and anhydrous ethanol. Preferably, the concentration of the aluminate coupling agent in the organic solution may be about 30-40% in weight (or mass). The amount of the organic coupling agent used for the plastic stone composite may be about 0.3-0.5 percent (in weight) of the raw coarse whiting powder included in the plastic stone composite.

In another embodiment, the inorganic coupling agent solution may include a mixture of the silane coupling agent (e.g. including compounds of silicon and hydrogen) and anhydrous ethanol. Preferably, the concentration of the silane coupling agent in the inorganic solution may be about 30-40 percent in weight. The amount of the inorganic coupling agent used for the plastic stone composite may be about 0.1-0.3 percent (in weight) of the raw coarse whiting powder included in the plastic stone composite.

The following exemplary embodiments are described for illustrative purposes and not limiting.

### Example 1

A plastic stone composite material can be formed via a uniform mixture of about 30 weight parts of PVC resin of grade SG-9, about 50 weight parts of coarse whiting powder with particle sizes of about 400-800 mesh, about 2 weight parts of calcium zinc stabilizer (e.g. calcium zinc complex stabilizer), about 0.3 weight parts of polyethylene wax, about 2 weight parts of chlorinated polyethylene, about 0.5 weight parts of stearic acid, about 1.5 weight parts of phthalate dioctyl, and about 1.2 weight parts of ACR (acrylic) processing aid. The mixture may be put into a twin screw extruder (or other applicable extruder) to be heated and melted at about 210° C. to be formed via extrusion granulation.

### Example 2

A plastic stone composite material can be formed via a uniform mixture of about 50 weight parts of PVC resin of grade SG-9, about 70 weight parts of coarse whiting powder with particle sizes of about 600 mesh, about 3 weight parts of calcium zinc stabilizer, about 0.5 weight parts of polyethylene wax, about 2.5 weight parts of chlorinated polyethylene, about 0.8 weight parts of stearic acid, about 2 weight parts of phthalate dioctyl, and about 1.6 weight parts of ACR processing aid. The mixture may be put into a twin screw extruder (or other applicable extruder) to be heated and melted at about 200° C. to be formed via extrusion granulation.

### Example 3

A plastic stone composite material can be formed via a uniform mixture of about 50 weight parts of PVC resin of grade SG-9, about 50 weight parts of coarse whiting powder with particle sizes of about 800 mesh, about 2.5 weight parts of calcium zinc stabilizer, about 0.4 weight parts of polyethylene wax, about 2.2 weight parts of chlorinated polyethylene, about 0.6 weight parts of stearic acid, about 1.8 weight parts of phthalate dioctyl, and about 1.5 weight parts of ACR processing aid. The mixture may be put into a twin screw extruder (or other applicable extruder) to be heated and melted at about 190° C. to be formed via extrusion granulation.

### Example 4

The coarse whiting powder may be prepared via surface treatments for a plastic stone composite material formed via a uniform mixture with component weight parts similar to example 1, example 2, or example 3. The surface treatments may include a first surface treatment by mixing about 100 kg of the coarse whiting powder with an aluminate coupling agent solution as a first mixture for about 60 minutes. Subsequently, in a first surface treatment, the first mixture may be further mixed with a silane coupling agent solution as a second mixture for about another 60 minutes. Then, the second mixture may be vacuum dried to retrieve the surface treated coarse whiting powder.

The aluminate coupling agent solution may be made of a mixture of about 30 percent weight density of aluminate coupling agent in anhydrous ethanol. The amount (weight) of the aluminate coupling agent may be about 0.3 percent of the (e.g. 100 kg) coarse whiting powder. The silane coupling agent solution may be made by a mixture of about 30 percent weight density of silane coupling agent in anhydrous ethanol. The weight amount of the silane coupling agent may be about 0.3 percent weight of the coarse whiting powder (e.g. 100 kg) used.

### Example 5

The coarse whiting powder may be prepared via surface treatments for a plastic stone composite material formed via a uniform mixture with component weight parts similar to example 1, example 2, or example 3. The surface treatments may include a first surface treatment by mixing about 100 kg of the coarse whiting powder with aluminate coupling agent solution as a first mixture for about 90 minutes. Subsequently, in a first surface treatment, the first mixture may be further mixed with silane coupling agent solution as a second mixture for about another 40 minutes. Then, the second mixture may be vacuum dried to retrieve the surface treated coarse whiting powder.

The aluminate coupling agent solution may be made of a mixture of about 40 percent weight density of aluminate coupling agent in anhydrous ethanol. The amount (weight) of the aluminate coupling agent may be about 0.5 percent of the (e.g. 100 kg) coarse whiting powder. The silane coupling agent solution may be made by a mixture of about 40 percent weight density of silane coupling agent in anhydrous ethanol. The weight amount of the silane coupling agent may be about 0.1 percent weight of the coarse whiting powder (e.g. 100 kg) used.

### Example 6

The coarse whiting powder may be prepared via surface treatments for a plastic stone composite material formed via a uniform mixture with component weight parts similar to example 1, example 2, or example 3. The surface treatments may include a first surface treatment by mixing about 100 kg of the coarse whiting powder with aluminate coupling agent solution as a first mixture for about 80 minutes. Subsequently, in a first surface treatment, the first mixture may be further mixed with silane coupling agent solution as a second mixture for about another 50 min (or a period of time more than about 15-30 min). Then, the second mixture may be vacuum dried to retrieve the surface treated coarse whiting powder.

The aluminate coupling agent solution may be made of a mixture of about 35 percent weight density of aluminate coupling agent in anhydrous ethanol. The amount (weight) of the aluminate coupling agent may be about 0.4 percent (e.g. 100 kg) of the coarse whiting powder. The silane coupling agent solution may be made by a mixture of about 35 percent weight density of silane coupling agent in anhydrous ethanol. The weight amount of the silane coupling agent may be about 0.2 percent weight of the coarse whiting powder (e.g. 100 kg) used.

The advantages of the plastic stone composite as disclosed may include at least (a) applicability of surface stamping/printing processing to provide natural stonelike appearances; (b) weight lighter than actual stones in for ease of manufacturing and use; (c) strength higher and less fragile than natural stone; (d) the production of which is environmentally friendly and pollution-free (e.g. little, undetectable or below safety level of benzene, formaldehyde etc.); and (e) recyclable to reduce amount of usage of raw ingredients.

Table 1 describes a list of exemplary physical characteristics or properties of the plastic stone composite material according to some embodiments of the instant invention:

TABLE 1

| Test Properties | Test Results | Desired Results |
|---|---|---|
| Appearance | Smooth surfaces without | Smooth surfaces without |
| | cracks, scratches, and | cracks, scratches, and |
| | uneven parts caused | uneven parts caused |
| | by abrasive defects | by abrasive defects |
| Moisture content | 0.33% | less than 2% |
| Hardness | 71.7 HRR (Rockwell R | >58 HRR |
| | Hardness) | |
| Thickness expansion rate of | 0.089% | <1% |
| water absorbing | | |
| Bending strength | 26.3 mpa (Megapascals) | >20 mpa (Megapascals) |
| Flexural Modulus of Elasticity | 3555 mpa | >1800 mpa |
| Surface abrasion resistance | 0.0579 g/100r (mass loss | <0.08 g/100r |
| | in gram per 100 cycle | |
| | tests) | |
| Low temperature drop test | 0 fractures | <=1 fracture |
| State of heating 150° C. | No bubble, crack, pitting | No bubble, crack, pitting |
| Dimensional change rate after | 0.8% | within +/− 2.5% |
| heating | | |
| Screw holding capability of the | 5261 N (Newton) | >1000 N |
| main surface (amount of force | | |
| required to remove a standard | | |
| testing screw) | | |
| Screw holding capability of the | 6618 N | >1000 N |
| side surface | | |
| High and low temperature | −0.18% | within +/− 0.2% |
| repeated change rate | | |
| 4-point Flexural performance | Max load 3.96 kN, | |
| test, based on ASTM (American | bending strength 20.5 | |
| Society for Testing and | mpa | |
| Materials) D6 109-05 method A, | | |
| test conditions including | | |
| specimen: 502 × 145 × 21 mm, | | |
| support span: 342 mm, and | | |
| testing speed: 10.1 mm/min | | |

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A plastic stone composite, the composite comprising:
about 30-50 parts by weight of PVC (polyvinyl chloride) having low molecular weight grade, wherein K value of the PVC having low molecular weight grade is less than 60;
about 50-70 parts by weight of calcium carbonate powder characterized by particle sizes smaller than 400 mesh; and
about 7.5-10.4 parts by weight of more than one additives.

2. The composite of claim 1, wherein the additives comprise:
about 2-3 parts by weight of calcium zinc stabilizer;
about 2-2.5 parts by weight of chlorinated polyethylene;
about 0.3-0.5 parts by weight of polyethylene wax;
about 0.5-0.8 parts by weight of stearic acid;
about 1.5-2 parts by weight of plasticizer; and
about 1.2-1.6 parts by weight of acrylic processing aid.

3. The composite material according to claim 1, wherein the K value of the PVC having low molecular weight grade is less 55.

4. The composite material according to claim 1, wherein the particle sizes of the calcium carbonate powder are larger than 800 mesh.

5. The composite material according to claim 2, wherein the plasticizer comprises dioctyl phthalate.

6. The composite of claim 1, wherein the calcium carbonate powder comprises calcium carbonate particles, wherein surfaces of the calcium carbonate particles have been treated with more than one treating agents including a dispersing agent for uniform dispersion of the calcium carbonate particles.

7. The composite of claim 5, wherein the dispersing agent comprises aluminum acetate.

8. The composite of claim 5, wherein the surface treating agents include silane coupling agent to provide bonding between the dispersing agent and the calcium carbonate particles.

9. A process to prepare plastic stone composite, the process comprising:
providing PVC (polyvinyl chloride) about 30-50 parts by weight, the PVC having low molecular weight grade with K value less than 60;
surface treating calcium carbonate powder with at least two treating agents for uniform dispersion among calcium carbonate particles of the powder, wherein the calcium carbonate particles are sized between 400 and 800 mesh, wherein the at least two treating agents comprise one organic agent having aluminum acetate and one inorganic agent having silane;
mixing the surface treated powder about 50-70 parts by weight, more than one additives about 7.5-10.4 parts by weight and the PVC into a mixture;
melting the mixture heated at about 190-210 Celsius degree.

10. The method to claim 9, wherein the more than one additives comprise: calcium zinc stabilizer about 2-3 parts by weight, chlorinated polyethylene about 2-2.5 parts by weight, polyethylene wax about 0.3-0.5 parts by weight, stearic acid about 0.5-0.8 parts by weight, plasticizer about 1.5-2 parts by weight and acrylic processing aid about 1.2-1.6 by weight.

11. The method of claim 9, wherein the one organic agent comprises aluminum acetate having a mass concentration about 30-40 percent mixed with anhydrous ethanol, wherein the aluminum acetate is about 0.3-0.5 weight percent of the calcium carbonate powder.

12. The method of claim 9, wherein the one inorganic agent comprises silane coupling agent having a mass concentration about 30-40 percent mixed with anhydrous ethanol, wherein the saline coupling agent is about 0.1-0.3 weight percent of the calcium carbonate powder.

13. The method of claim 9, wherein the surface treating comprising:
mixing the organic agent with the calcium carbonate powder as a first mixture; and
mixing the first mixture with the inorganic agent for a period of time about more than 30 minutes.
